(19) United States
(12) Patent Application Publication
(10) Pub. No.: US 2012/0107066 A1
(43) Pub. Date: May 3, 2012

(54) Devices for Securing Cargo

(75) Inventor: Steve F. Askari, Marietta, GA (US)

(73) Assignee: Askari Enterprisies, LLC., Marietta, GA (US)

(21) Appl. No.: 13/077,040

(22) Filed: Mar. 31, 2011

Related U.S. Application Data
(60) Provisional application No. 61/407,979, filed on Oct. 29, 2010.

(51) Int. Cl. B60P 7/06

(52) U.S. Cl. 410/96; 410/120

(57) ABSTRACT

Devices for securing cargo in the bed of a truck having tie-down anchors are provided. A representative device includes: a body sized and shaped to span a width of cargo to be secured in the bed of the truck, the body having a first segment and a second segment; a first attachment member connected to the first segment; and a second attachment member spaced from the first attachment member and being connected to the first segment; the first attachment member and the second attachment member being operative to be secured in position relative to first and second ones of the tie-down anchors of the truck such that the cargo is positioned between the truck bed and the body of the device.

### CROSS REFERENCE TO RELATED APPLICATION

This utility application claims priority to U.S. Provisional patent application having Ser. No. 61/407,979, which was filed on Oct. 29, 2010, and which is incorporated herein by reference in its entirety.

### BACKGROUND

1. Technical Field

The present application relates to cargo retention devices for vehicles.

2. Description of the Related Art

Loads (e.g., dimensional lumber) carried by trucks often exceed the available lengths of the truck beds. Because of this, a portion of such a load typically extends out beyond the truck bed. For instance, one end of the load may be placed up against the cab end of the bed, while the other extends out over the closed gate of the truck. Unfortunately, this can create an unsafe condition because it becomes difficult to secure the load

### SUMMARY

Devices for securing cargo are provided. In an exemplary embodiment, such a device comprises: a body sized and shaped to span a width of cargo to be secured in the bed of the truck, the body having a first segment and a second segment; a first attachment member connected to the first segment; and a second attachment member spaced from the first attachment member and being connected to the first segment; the first attachment member and the second attachment member being operative to be secured in position relative to first and second ones of the tie-down anchors of the truck such that the cargo is positioned between the truck bed and the body of the device.

In another representative embodiment, the device comprises: a body sized and shaped to span a width of cargo to be secured in the bed of the truck, the body having a first segment and a second segment, the first segment being a length of tubing with a first crimped end and a second crimped end; a first attachment member having a first hook positioned at a distal end thereof, the first attachment member being connected to the first crimped end of the first segment; and a second attachment member having a second hook positioned at a distal end thereof, the second attachment member being connected to the second crimped end of the first segment; the first hook and the second hook being spaced from each other to accommodate engaging first and second ones of the tie-down anchors of the truck such that the cargo is positioned between the truck bed and the body.

Other systems, methods, features and/or advantages will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a device for securing cargo.

FIG. 2 is a schematic diagram of the device of FIG. 1 in an installed position.

FIGS. 3-18 are schematic diagrams depicting other exemplary embodiments.

### DETAILED DESCRIPTION

Devices for securing cargo are provided. In some embodiments, the device is well suited for transporting material (lumber, piping, etc.), which is longer than the cargo area of a vehicle (e.g., the bed of a truck). Specifically, such an embodiment can securely retain the material at the front end of the truck bed, so that the material is prevented from “see-sawing” out of the truck. By way of example, some embodiments may facilitate the transport of 18′ lumber in a truck with a bed length of 5′. It should be noted that, although some embodiments may be structurally capable of securing such loads, an operator should always consider other cautionary measures to ensure the safety of the load.

As shown in the figures, various embodiments of the device include multiple attachment members (e.g., four such members) that are spaced from each other and located generally about the periphery of the device. The attachment members, which can include hooks, are positioned to engage tie-down anchors (strap rings) of a truck bed either directly, or through use of an associated tie-down strap or cordage that interconnects an attachment member to a tie-down anchor.

The body of such a device spans generally between the attachment members and is sized to span across the secured end of a load. In some embodiments, the body incorporates multiple body segments that can be formed of various materials and configurations of materials. By way of example, some segments can be formed of metal tubing, which can be crimped at ends of the segments to provide surfaces for facilitation connection (such as by welding, for example) with adjacent components.

In some embodiments, at least a portion of the device can be covered in material (such as foam padding, for example) to protect the load and/or enhance frictional engagement between the device and the load.

The device can be very light weight and durable (e.g., made of 14 or 18 Gauge steel tubing) to withstand impressive weight loading, while keeping the load down in the truck bed. The device can be universal for any truck that is equipped with the tie-down anchors in the bed.

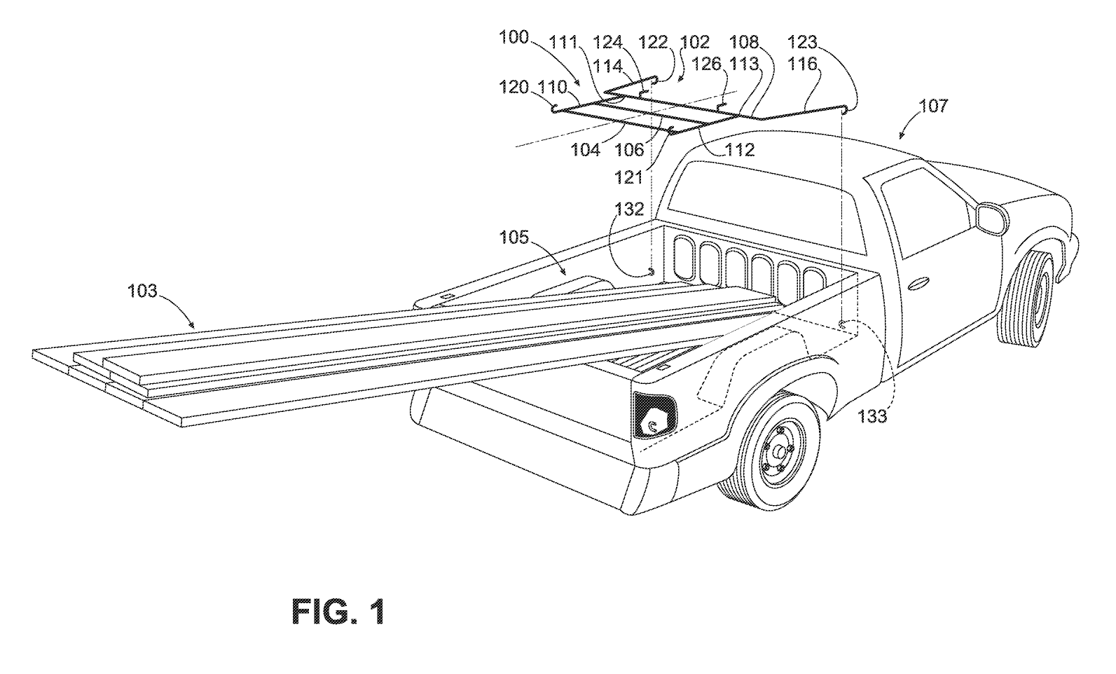

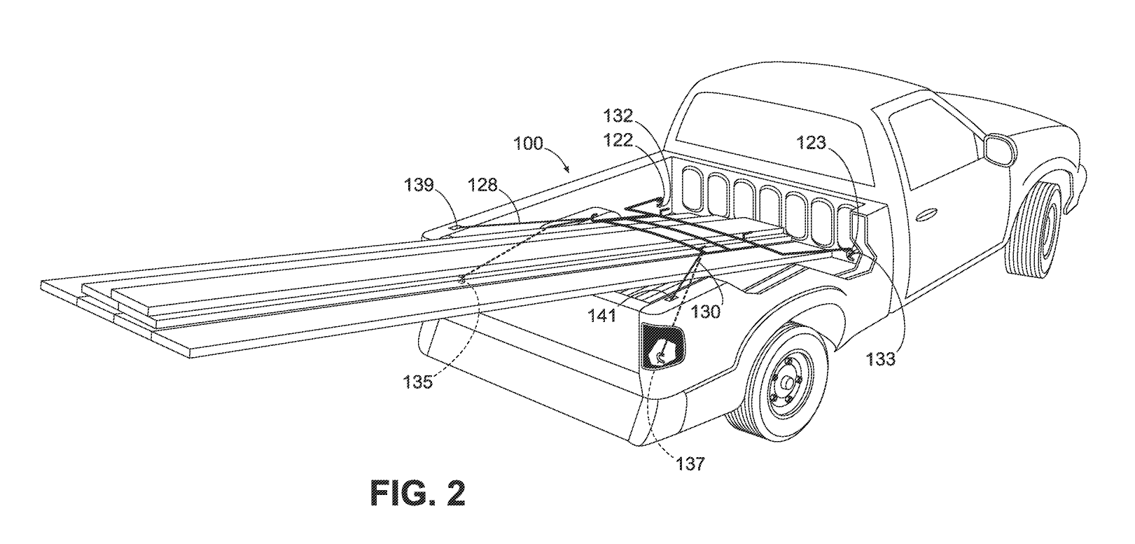

FIGS. 1 and 2 are schematic diagrams depicting an exemplary embodiment of a device for securing cargo. As shown most clearly in FIG. 1, device 100 includes a body 102 that is sized and shaped to span (preferably fully, but at least partially) a width of cargo (e.g., lumber 103) that is to be secured in the bed 105 of a truck 107. In this embodiment, the body incorporates three parallel segments (104, 106, 108), with each of the segments being formed of a length of metal rod. Notably, in other embodiments, various other numbers and configurations of segments, and/or other materials, can be used.

Attachment members 110, 112 are positioned in parallel at opposing ends of segments 104 and 106, while proximal ends 111, 113 of the attachment members connect at intermediate locations of segment 108. Additionally, attachment members 114, 116 are positioned at opposing ends of segment 108. Notably, attachment members 110, 112 are generally perpendicular to the segments, whereas attachment members 114, 116 extend outwardly from a centerline of the device to form obtuse included angles with respect to segment 108. In this embodiment, connection of the attachment members and segments is facilitated by welding.

Each of the attachment members includes an attachment feature that facilitates attachment of the device to tie-down anchors of a vehicle. In this embodiment, the attachment features are configured as hooks 120, 121, 122 and 123 that can be engaged by various tie-downs (e.g., cordage or straps). Hooks 120 and 121 extend upwardly and inwardly while hooks 122 and 123 extend downwardly and inwardly. In other embodiments, various other configurations and orientations of attachment features can be used.

Further, arms 124 and 126 extend outwardly and downwardly from the body (in this case, outwardly from segment 108 and downwardly away from segment 102).

As shown in FIG. 2 (which depicts an installed position of the device), hooks 122 and 123 directly engage tie-down anchors 132, 133 of the truck. Additionally, hooks 120 and 121 are engaged by cordage 128, 130, which then engage tie-down anchors 135 and 137, as well as apertures 139 and 141. So positioned, the device spans the width of the load while retaining the front end of the load downwardly and toward the front end of the truck bed. This retention permits a substantial portion of the load to extend beyond the tailgate of the vehicle while being securely retained to the vehicle by the device.

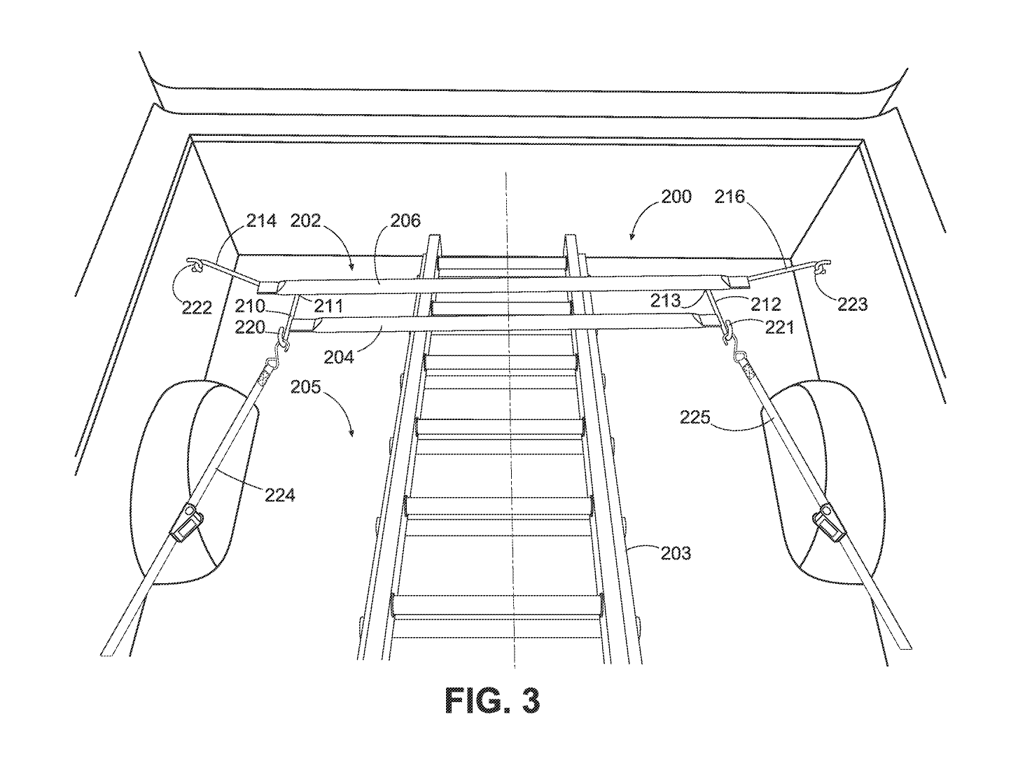

FIG. 3 is a schematic diagram depicting another exemplary embodiment of a device for securing cargo. In FIG. 3, device 200 includes a body 202 that is sized and shaped to span a width of cargo (e.g., ladder 203) that is to be secured in the bed 205 of a vehicle. In this embodiment, the body incorporates two segments (204, 206), with each of the segments being formed of an uninterrupted length of metal tubing.

Attachment members 210, 212 are positioned at opposing ends of segment 204, while proximal ends 211, 213 of the attachment members connect at intermediate locations of segment 206. Additionally, attachment members 214, 216 are positioned at opposing ends of segment 206. Notably, attachment members 210, 212 are generally perpendicular to the segments, whereas attachment members 214, 216 extend outwardly from a centerline of the device to form obtuse included angles with respect to segment 206. In this embodiment, connection of the attachment members and segments is facilitated by welding the attachment members at crimped ends of the segments.

Attachment features 220, 221, 222 and 223 are positioned at ends of the attachment members. In this embodiment, the attachment features are configured as hooks, with features 220 and 221 extending upwardly and inwardly and features 222 and 223 extending inwardly and back toward the body.

Also shown in FIG. 3 are removable tie-down straps 224 and 225 that are independently adjustable in length. Straps 224 and 225 engage features 220 and 221, respectively, while free ends of the straps engage tie-down anchors of the vehicle.

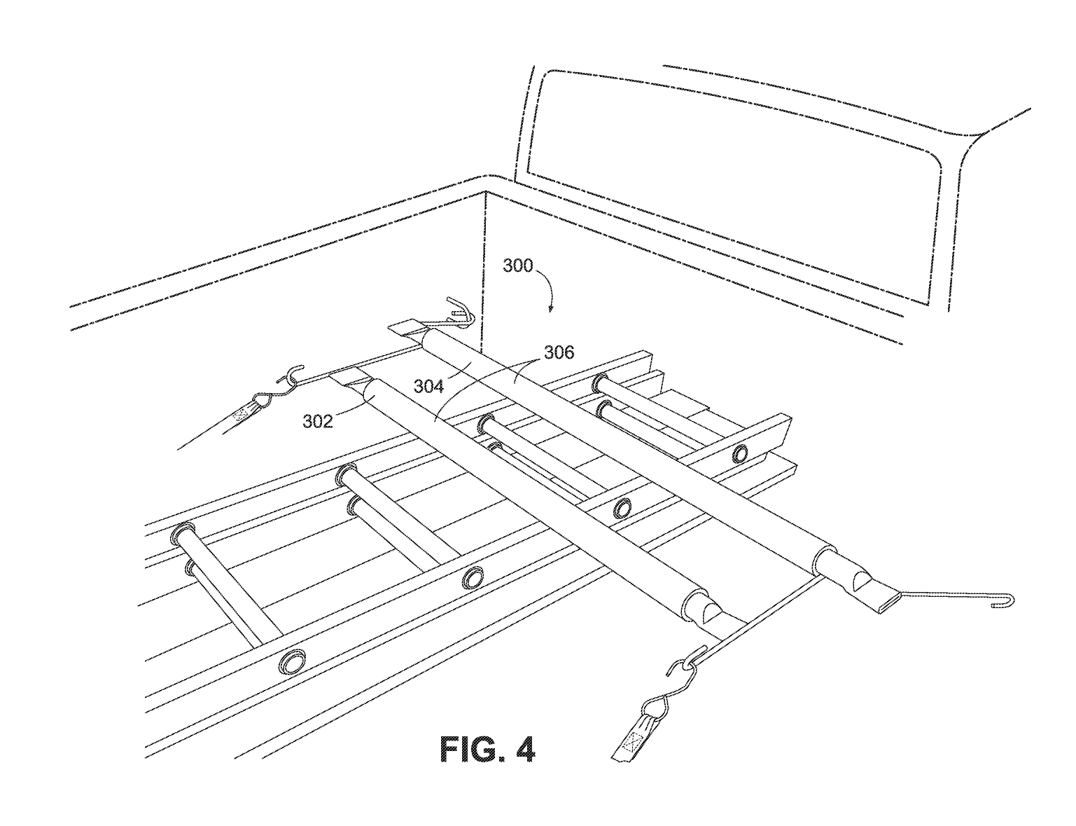

FIG. 4 depicts another embodiment of a device. In particular, device 300 is similar in many respects to device 200 of FIG. 3. However, device 300 additionally incorporates a covering that extends across at least a portion of the segments. Notably, covering 306 in this embodiment is formed of foam padding material that is configured to cushion contact between the device and a load. In other embodiments, various other types and configurations of coverings can be used. By way of example, coverings can be used to enhance frictional engagement of the device and the load.

FIG. 5 is a schematic diagram depicting another exemplary embodiment of a device for securing cargo. As shown in FIG. 5, device 400 includes a body 402 that incorporates three segments (404, 406, 408), with each of the segments being formed of an uninterrupted length of metal tubing.

Attachment members 410, 412 are positioned at opposing ends of segments 404, 406, while proximal ends 411, 413 of the attachment members connect at intermediate locations of segment 408. Additionally, attachment members 414, 416 are positioned at opposing ends of segment 408. Attachment features 420, 421, 422 and 423 are positioned at ends of the attachment members. Device 400 additionally incorporates foam padding material 418 for cushioning contact between the device and a load.

Further, arms 417 and 419 extend outwardly from the body.

Also shown in FIG. 5 are tie-downs 424 and 425 that engage between features 420 and 421, respectively, and tie-down anchors 426 and 428, respectively.

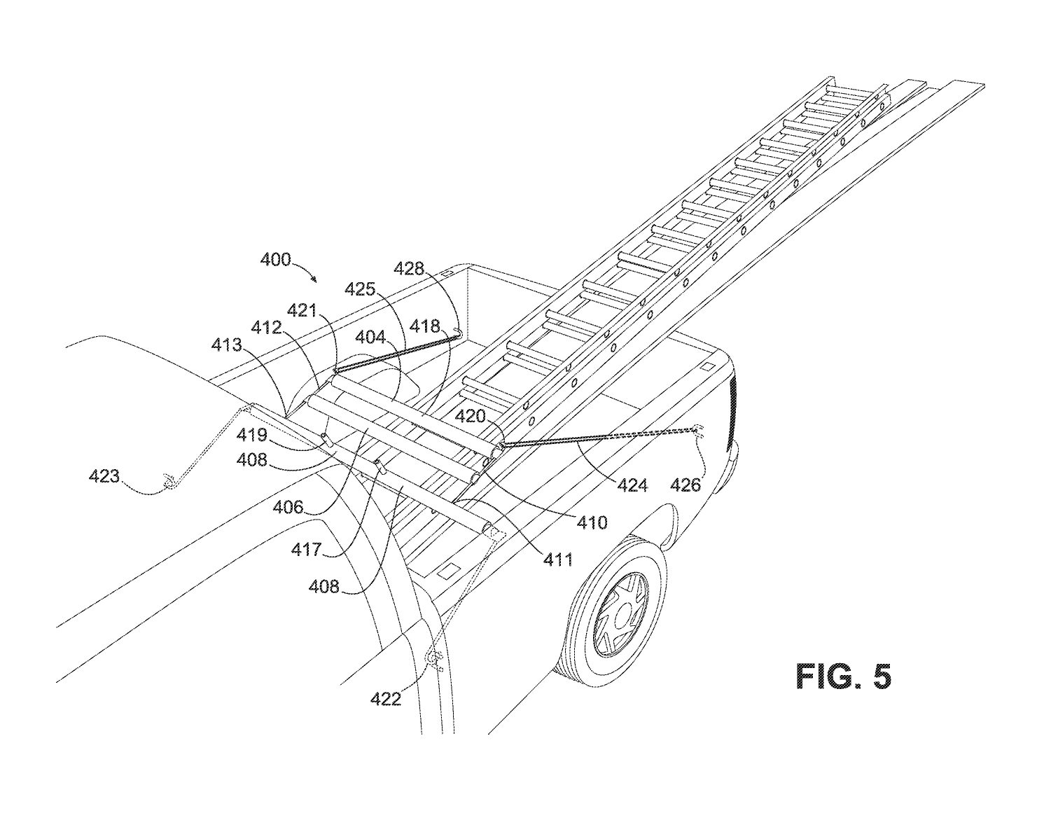

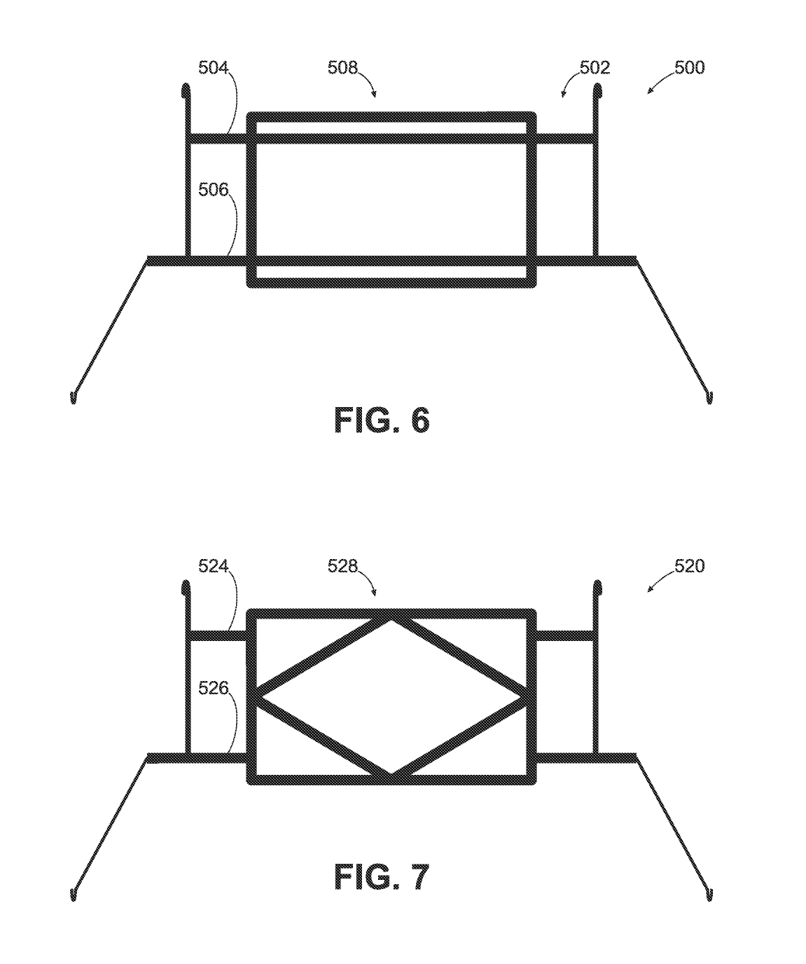

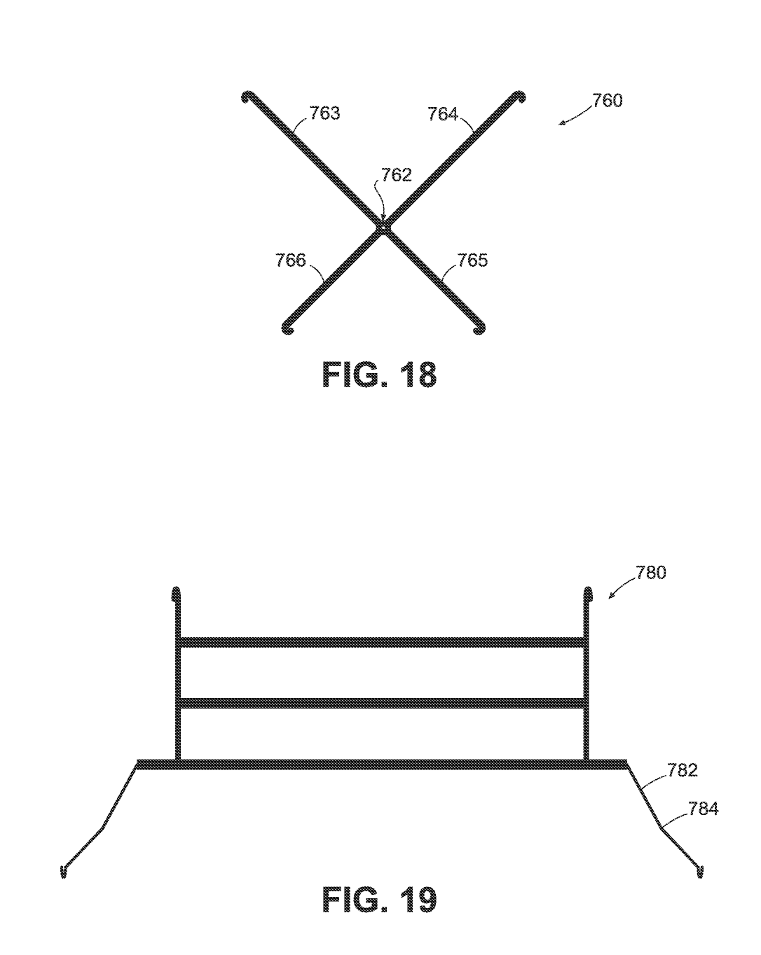

FIGS. 6-18 are schematic diagrams depicting other exemplary embodiments that are presented for highlighting various configurations. By way of example, device 500 of FIG. 6 includes a body 502 that incorporates an intermediate section 508 in addition to segments 504 and 506. In this embodiment, section 508 is generally rectangular and is attached to corresponding lower sides of the segments 504, 506. Notably, section 508 provides an enlarged area for engaging a load.

Device 520 of FIG. 7 includes a body 520 that incorporates an intermediate section 528 in addition to interrupted segments 524 and 526. In this embodiment, section 528 is generally rectangular and is attached to the segments 524, 526 at intermediate locations thereof such that the segments and the section are oriented in the same plane.

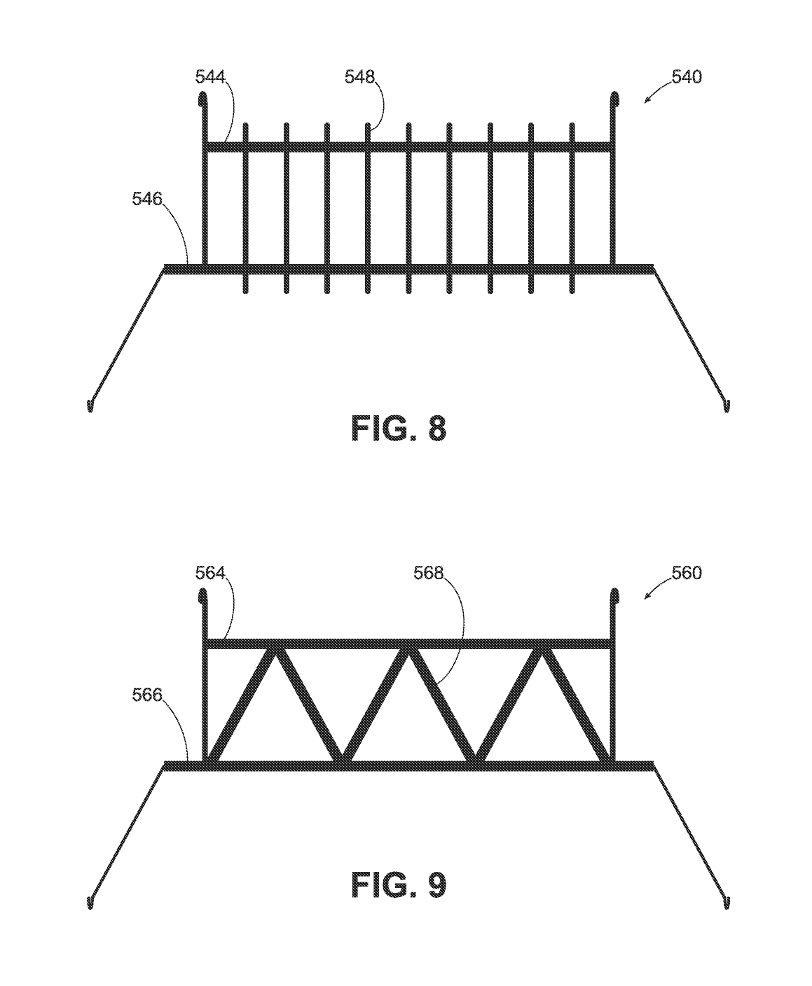

Device 540 of FIG. 8 includes support members (e.g., member 548) in addition to segments 544 and 546. In this embodiment, each support member is generally linear, with the members being attached to the segments at regularly spaced intervals along the lengths of the segments. Notably, each of the support members is generally perpendicular to the segments, with ends of the members extending beyond the segments.

In contrast, device 560 of FIG. 9 includes support members (e.g., member 568) in addition to segments 564 and 566. Each support member is generally linear, with the members being attached to the segments in a chevron configuration.

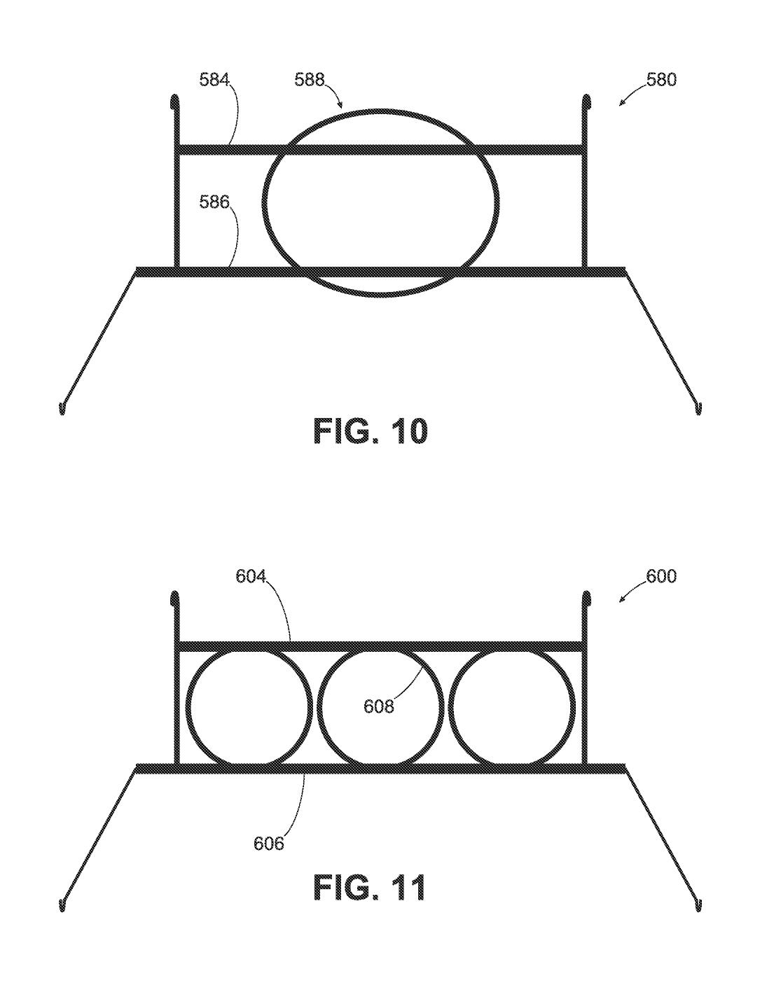

Device 580 of FIG. 10 incorporates an intermediate section 588 in addition to segments 584 and 586. In this embodiment, section 588 is generally oval and is attached to corresponding lower sides of the segments 584, 586. In the embodiment of FIG. 11, device 600 includes multiple circular support members (e.g., member 608) that span segments 604, 606.

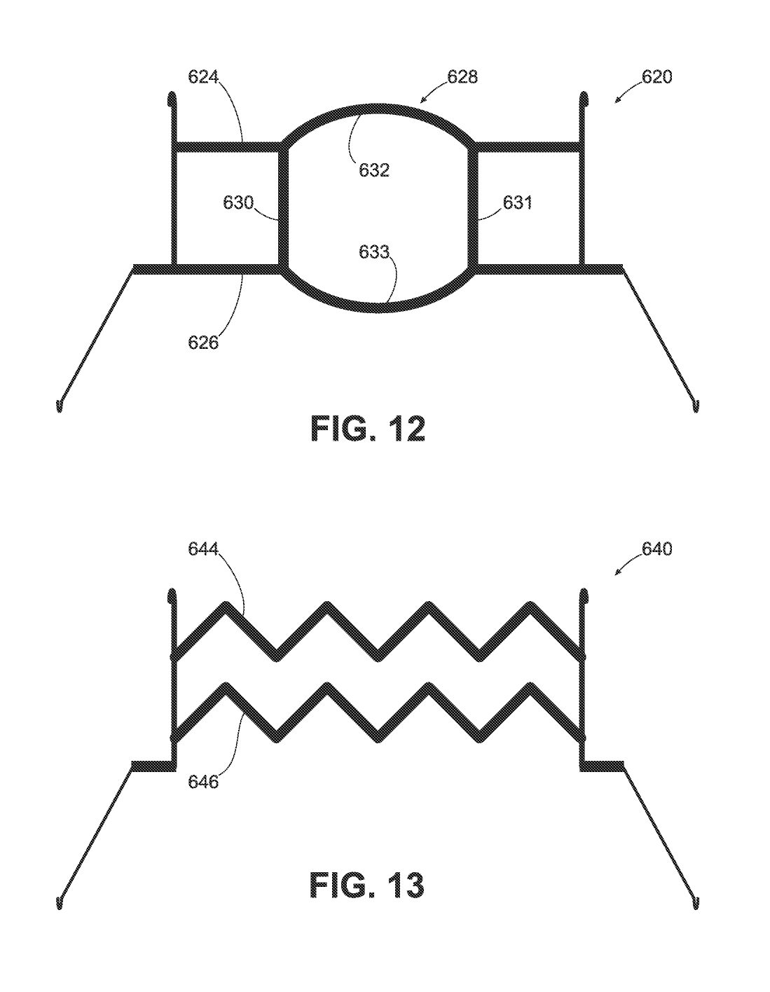

Device 620 of FIG. 12 includes an intermediate section 628 in addition to interrupted segments 624 and 626. In this embodiment, section 628 incorporates opposing members 630, 631 that span the segments, and opposing arcuate members 632, 633 that interconnect the members 630, 631.

Device 640 of FIG. 12 includes nonlinear segments 644 and 646. Each of the segments exhibits a generally saw tooth configuration.

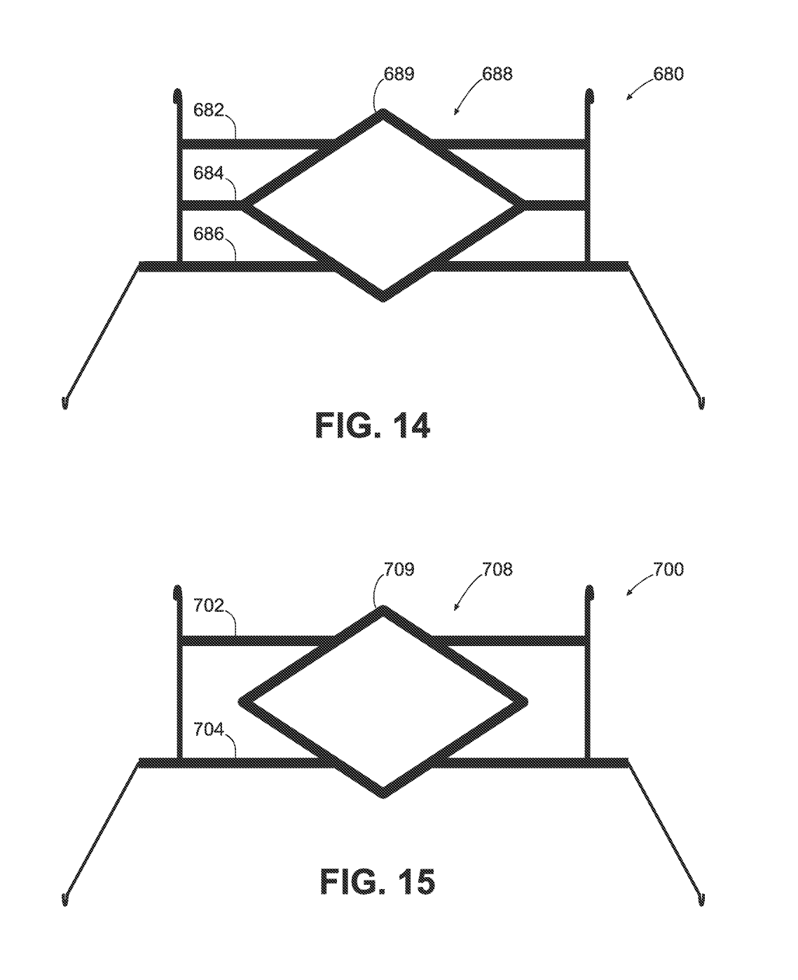

Devices 680 and 700 of FIGS. 14 and 15, respectively, each include intermediate sections. Specifically, device 680 includes section 688 that is positioned along interrupted segments 682, 684 and 686. In device 700, section 708 is included that is positioned along interrupted segments 702 and 704. Both of sections 688 and 708 include portions (e.g., portions 689, 709) that extend outwardly beyond the outward edges of the segments.

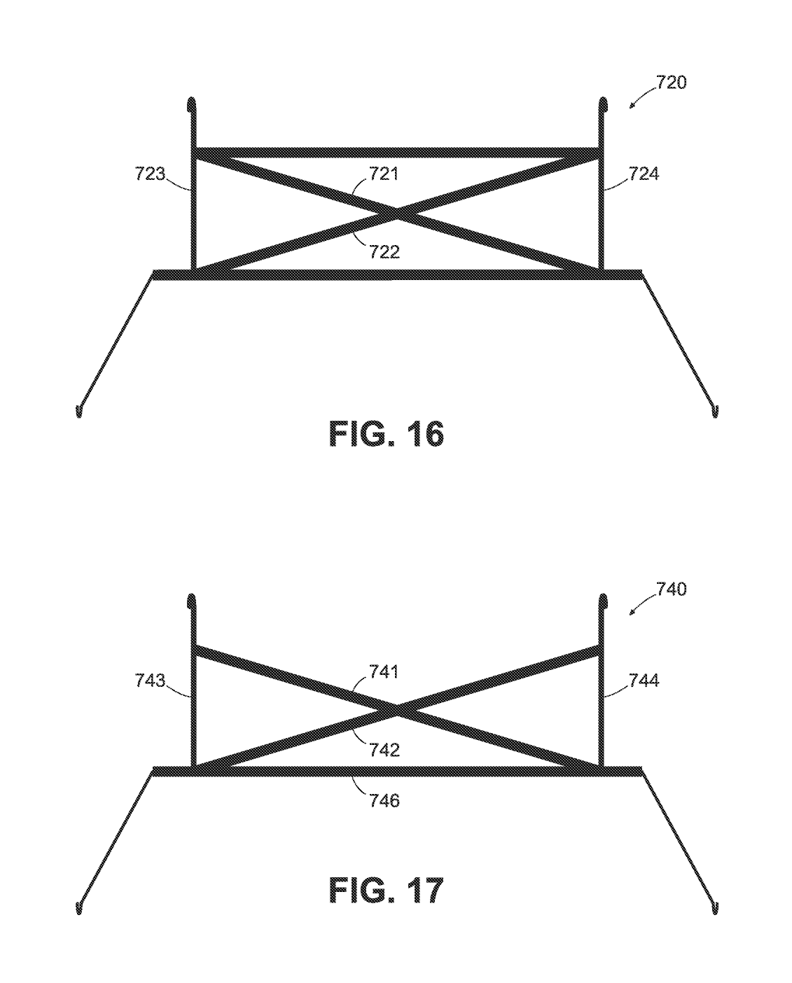

Devices 720 and 740 of FIGS. 16 and 17, respectively, each include support members that extend between opposing attachment members. Specifically, support members 721 and 722 extend between attachment members 723, 724, whereas support members 741 and 742 extend between attachment members 743, 744. Notably, the support members are generally linear and intersect each other at intermediate locations. Note also that device 720 includes two segments 726, 728, whereas device 740 includes only one segment 746.

Device 760 is an embodiment that incorporates a relatively small body 762 from which attachment members 763, 764, 765 and 766 extend.

Device 780 is an embodiment that incorporates attachment members that are configured with an intermediate bend. For example, member 782 exhibits a bend 784.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, various materials and dimensions can be used. All such modifications and variations are intended to be included herein within the scope of this disclosure and protected by the accompanying claims.

1. A device for securing cargo in the bed of a truck having tie-down anchors, the device comprising:
a body sized and shaped to span a width of cargo to be secured in the bed of the truck, the body having a first segment and a second segment, the first segment being a length of tubing with a first crimped end and a second crimped end;
a first attachment member having a first hook positioned at a distal end thereof, the first attachment member being connected to the first crimped end of the first segment; and
a second attachment member having a second hook positioned at a distal end thereof, the second attachment member being connected to the second crimped end of the first segment;
the first hook and the second hook being spaced from each other to accommodate engaging first and second ones of the tie-down anchors of the truck such that the cargo is positioned between the truck bed and the body.

2. The device of claim 1, wherein:
the device further comprises a third attachment member and a fourth attachment member;
the third attachment member has a third hook positioned at a distal end thereof, the third attachment member being connected to the second segment; and
the fourth attachment member has a fourth hook positioned at a distal end thereof, the fourth attachment member being connected to the second segment;
the third hook and the fourth hook being spaced from each other.

3. The device of claim 2, wherein:
the third attachment member has a distal end, at which the third hook is positioned, and a proximal end, which is connected to the first segment; and
the fourth attachment member has a distal end, at which the fourth hook is positioned, and a proximal end, which is connected to the first segment.

4. The device of claim 2, wherein the device further comprises a first removable tie-down strap operative to engage between a third of the tie-down anchors and the third hook, and a second removable tie-down strap operative to engage between a fourth of the tie-down anchors and the fourth hook.

5. The device of claim 4, wherein the first removable tie-down strap and the second removable tie-down strap are independently adjustable in length.

6. The device of claim 1, wherein at least a portion of the first segment is covered in foam padding.

7. The device of claim 1, wherein the first segment is an uninterrupted length of tubing extending between the first crimped end and the second crimped end.

8. A device for securing cargo in the bed of a truck having tie-down anchors, the device comprising:
a body sized and shaped to span a width of cargo to be secured in the bed of the truck, the body having a first segment and a second segment;
a first attachment member connected to the first segment; and
a second attachment member spaced from the first attachment member and being connected to the first segment;
the first attachment member and the second attachment member being operative to be secured in position relative to first and second ones of the tie-down anchors of the truck such that the cargo is positioned between the truck bed and the body of the device.

9. The device of claim 8, wherein:
the first attachment member has a first hook; and
the second attachment member has a second hook.

10. The device of claim 8, wherein the device further comprises a first removable tie-down strap operative to engage between the first of the tie-down anchors and the first attachment member, and a second removable tie-down strap operative to engage between the second of the tie-down anchors and the second attachment member.
